(19) United States
(12) Patent Application Publication
(10) Pub. No.: US 2007/0115130 A1
(43) Pub. Date: May 24, 2007

(54) Multi-dimensional, broadband track and trace sensor radio frequency identification device

(76) Inventor: Ronald Eveland, Milwaukee, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/599,492

(22) Filed: Nov. 14, 2006

Related U.S. Application Data
(60) Provisional application No. 60/736,566, filed on Nov. 14, 2005.

(51) Int. Cl. G08B 13/14; H01Q 1/36

(52) U.S. Cl. 340/572.7; 343/700 R

(57) ABSTRACT

A broadband antenna constructed according to the present invention for use with an RFID tag device is formed with a three dimensional (3D) structure. The 3D structure of the antenna enables the antenna to be constructed with a size smaller than that of conventional two-dimensional antennas, consequently reducing the size of the overall tag device, but without any loss of efficiency. The 3D antennas can be tuned to a specific frequency in a particular frequency band, enabling many more unique RFID devices to be defined and operate within that band in conjunction with a reader utilizing a frequency-hopping method without interfering with one another. Additionally, the antenna can receive signals from a higher frequency band than the band in which the antenna resonates to enable those higher power signals to supply power to the device without interfering with the resonant frequency signals received by and transmitted from the RFID device.

### CROSS-REFERENCE TO RELATED APPLICATIONS

This application claims priority under 35 U.S.C. § 119 from U.S. Provisional Patent Application Ser. No. 60/736,566, filed on Nov. 14, 2005, and incorporated by reference in its entirety herein.

### FIELD OF THE INVENTION

The present invention relates, in general, to passive radio frequency identification (RFID) data tag devices, and more particularly to tags of this type that are formed with a three-dimensional antenna.

### BACKGROUND OF THE INVENTION

Current RFID tag designs use two-dimensional (2D) linearly polarized antennas to transmit and receive data from the tag. These antennas can be formed in any suitable manner, such as by being placed or wound onto the tag when formed of a wire coil, or by being printed directly on a substrate for the tag when formed of a conductive ink or metal etching. The antennas for the tags are formed to have particular length that enables the antenna to receive signals within the particular bandwidth to which the tags are tuned. The antennas are optimally designed to receive signals within a particular section of the frequency bandwidth in which they are operating. This enables the antennas, and consequently the RFID tags to which they are attached, to react to signals received from interrogating devices within this frequency band, and to transmit the read data or information contained on the tags via the antenna back to the device. The tuning of the antennas to a particular section of the frequency bandwidth also allows the antennas to ignore those additional transmissions within the assigned frequency bandwidth, but outside of the particular section of that bandwidth to which the antenna and RFID tag device are tuned.

However, with these types of antennas, there are certain inefficiencies associated with their design that limits the effectiveness of the RFID tags having 2D antennas. Initially, because the antennas are formed as a two-dimensional structure, the antennas must be sufficiently large to be capable of receiving the signals broadcast from a particular interrogating device with which the RFID tag is to be utilized. Thus, due to the required size for the 2D antenna, the RFID tag device including the antenna must be large enough to accommodate the entire antenna as well as the additional components of the tag. Most often, this requires that the RFID tag device be approximately four (4) inches square, rendering the tag device unworkable for many applications in which the item or section of the item to which the RFID tag device would be attached too small for use with RFID tag devices of this size.

Furthermore, based on the relatively large size of the bandwidth sections that the antennas are designed to operate in, multiple RFID tag devices modulating within the same area and within the same frequency bandwidth are often affected by signal interference. The reason for this is that the licensed and unlicensed frequencies in which RFID tag devices are designed for use have a limited amount of bandwidth. Because the 2D antennas can only be accurately formed or tuned below a limited bandwidth section, a correspondingly limited number of physical channels or sections are available within that bandwidth. Thus, when multiple RFID tag devices are being utilized in a given location, many of these tags will be operating within the same bandwidth section, and those devices operating on the same frequencies can cause signal interference, thereby affecting the signal quality of transmitted read data. Also, multiple overlapping channels, such as those sections to which RFID tag devices are tuned in a given bandwidth, can generate random, unnecessary signal interference. Therefore, for optimum RFID tag device operation, only a limited amount of RFID tag devices can be within the same area or read range, greatly reducing the utility of these prior art RFID tag devices.

Alternatively, to overcome this signal interference problem and achieve optimum operation of the RFID tag devices, each of the signals transmitted to the RFID tag device can be supplied with sufficient power to overcome any interference from other RFID tag devices operating within the same frequency bandwidth section in the vicinity. However, due to power constraints that are placed on the signals that can be utilized in a given frequency band, and specifically those which are available for use with RFID tag devices, oftentimes the maximum power for the signal to be received by the antenna for the RFID tag device is not sufficient to completely eliminate all interference from other RFID tag devices.

In addition, the 2D linearly polarized antennas used in current RFID tag designs reduce the optimum read angle of the device, further reducing the optimum power transfer from RFID tag device to RFID reader.

Therefore, it is desirable to develop an improved antenna construction for use with an RFID tag device that is smaller than existing antennas to reduce the size of the tag, and that greatly reduces any problems with signal interference between RFID tag devices because of area and signal range. It is also desirable that the improved antenna construction be capable of enhancing the ability to power passive RFID tag devices with signals from an interrogating or other device.

### SUMMARY OF THE INVENTION

According to a first aspect of the present invention, an antenna constructed according to the present invention for use with an RFID tag device is formed with a three dimensional (3D) structure. The 3D structure of the antenna enables the antenna to be constructed to have a size smaller than that of conventional two-dimensional antennas, consequently reducing the size of the overall tag device, but without any loss of efficiency of the 3D antenna compared to 2D antennas. Further, depending upon the particular shape of the 3D antenna, the directivity and optimum read angle of the antenna are increased significantly.

According to another aspect of the present invention, the 3D structure of the antenna of the present invention enables the antenna to be tuned to a more specific frequency within a particular frequency bandwidth. This is accomplished by forming the antenna with the desired 3D structure, regardless of the particular frequency that the antenna is to be utilized for. Once formed, initially the 3D antenna structure is capable of receiving signals over the entire frequency bandwidth for which the 3D antenna is designed. However, the 3D antenna is then connected to an appropriately-sized RFID tag device that includes a signal filter. The signal filter is the component of the RFID tag utilized to tune the 3D antenna, and consequently the RFID tag device, to the desired frequency. Thus, the same 3D antenna configuration can be utilized to receive and transmit signals at any particular frequency within the selected frequency bandwidth. The ability to tune the 3D antenna to a specific frequency in a selected bandwidth frees up many more frequencies and/or channels within that band, enabling many more unique RFID tag devices to operate within that band.

According to another aspect of the present invention, because the 3D antennas utilized on the RFID tag devices are each tuned to a highly specific frequency in the associated frequency bandwidth, each 3D antenna and its associated RFID tag device will function only in response to a matching signal frequency from an interrogating device. This increased signal frequency differentiation between varying 3D antennas and their associated RFID devices greatly reduces the potential for interference from generated by or for other RFID tag devices located in the same location. With the increased separation in the frequencies associated with different 3D antennas and RFID tag devices and consequent reduced interference, the power requirements for transmitting readable signals at the frequency for a particular device is also reduced.

According to still another aspect of the present invention, as a consequence of the individual frequencies to which the 3D antennas and RFID tag devices are tuned, with existing technologies that employ adaptive, sequential or random frequency hopping techniques, it is possible for interrogating devices to search for and identify individual RFID tags at numerous frequencies in the same location, e.g., multiple items on a single pallet, in a very expedient manner. This can greatly increase the speed of data acquisition and transmission from the respective RFID tags.

According to still a further aspect of the present invention, the ability to tune the 3D antenna to a highly specific frequency with the filter component of the RFID tag device enables the 3D antenna to receive signals at different frequencies for different purposes. More particularly, the 3D antenna can be tuned to resonate in response to signals at only a certain frequency in order to transmit data from the RFID tag device. However, due the broadband construction of the 3D antenna, the 3D antenna will receive signals sent at a much higher frequency, which has a correspondingly much higher maximum power level for the signal, in order to utilize that signal to power the RFID tag device. This allows the RFID tag device with the 3D antenna to have a higher output signal power, with a higher read range, as well as higher transmit antenna directivity and gains.

Numerous other aspects, features and advantages of the present invention will be made apparent from the following detailed description taken together with the drawing figures.

### BRIEF DESCRIPTION OF THE DRAWINGS

The drawing figures illustrate the best mode currently contemplated of practicing the present invention.

In the drawing figures:

FIG. 1 is an isometric view of a 3D antenna constructed according to the present invention;

FIG. 2 is an isometric view of a tag including the antenna of FIG. 1 secured to a suitable item;

FIG. 3 is a graph illustrating the return loss for the antenna of FIG. 1 constructed for use at 2.45 GHz;

FIG. 4 is a graph illustrating the return loss for the antenna of FIG. 1 constructed for use at 5.80 GHz;

FIG. 5 is a graph illustrating the return loss for the antenna of FIG. 1 constructed for use at 63 GHz;

FIG. 6 is a graph of the return loss of a narrowband 2D 2.45 GHz antenna modulated at 5.80 GHz;

FIG. 7 is a graph of the return loss of a narrowband 2D 63 GHz antenna modulated at 66 GHz;

FIG. 8 is a schematic view of an RLC circuit tuned to 2.45 GHz used with the antenna of the present invention;

FIG. 9 is a graph of the response of the circuit and antenna of FIG. 8;

FIG. 10 is a schematic view of an RLC circuit tuned to 63 GHz used with the antenna of the present invention; and

FIG. 11 is a graph of the response of the circuit and antenna of FIG. 10.

### DETAILED DESCRIPTION OF THE INVENTION

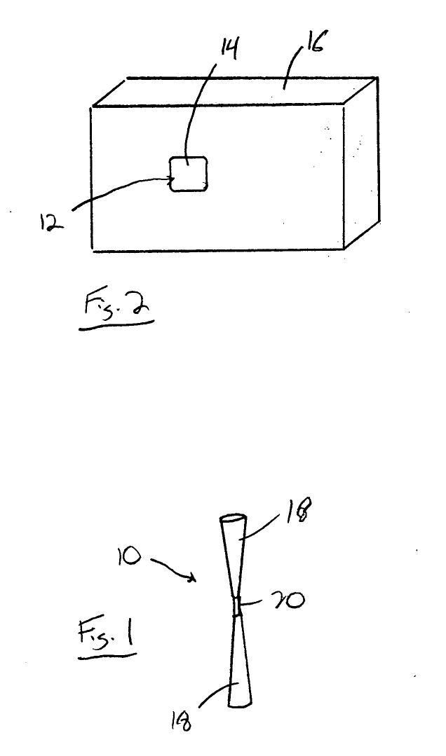

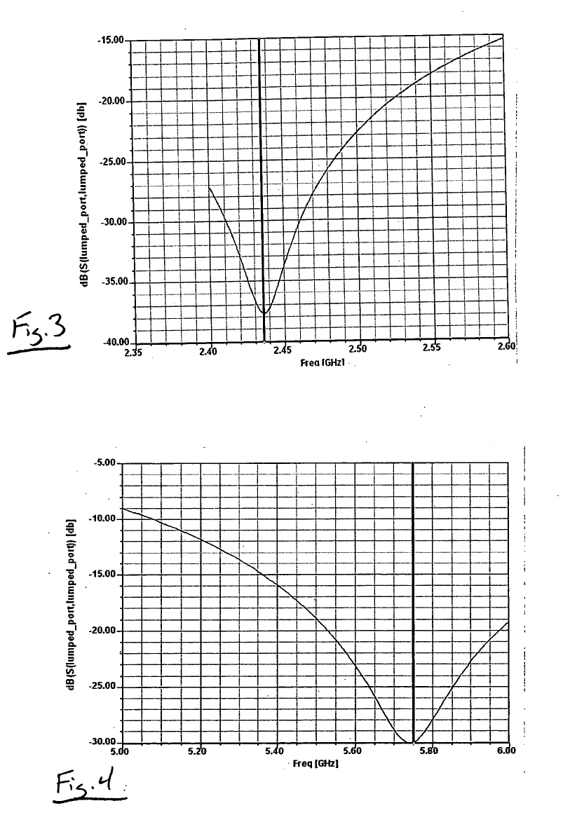

With reference now to the drawing figures in which like reference numerals designate like parts throughout the disclosure, a three-dimensional (3D) antenna constructed according to the present invention is indicated generally at 10 in FIG. 1. The antenna 10 is configured to be utilized with any suitable RFID tag device 12 that is employed in various item tracking and tracing systems, such as that disclosed in co-pending and co-owned U.S. patent application Ser. No. ______, which is incorporated by reference in its entirety herein.

The antenna 10 is adapted to be connected to the tag device 12 which includes a housing or label 14 that is adapted to be positioned on and secured to a single item, package or container 16 capable of holding drugs, foodstuffs, or other items. In addition, the housing or label 14 isolates the RFID tag device 12 from potential moisture interference, metal interference, or similar types of contact interference with the tag device 12. In this configuration, the tag 12 can be used to track and trace the containers 16 down to the single container level utilizing the attached RFID tag device 12 in conjunction with a suitable system. The tracking and tracing of the container 16 including the tag device 12 can occur from the point of manufacture of the container 16 to the disposal or recycling of the individual container 16 after usage. Thus, the tag device 12 including the antennas 10 disclosed herein may be used in a host of applications, including both manufacturing and non-manufacturing applications, for example in conjunction with a conventional shipping envelope or box.

In one embodiment of the present invention, a passive radio frequency identification tag 12 includes a 3D broadband, circular-polarized, antenna 10, although the tag device 12 utilized with the antenna 10 could also be an active RFID tag. The antenna 10 can be tuned within an unlicensed microwave frequency band or within an unlicensed millimeter frequency band, although the antennas 10 can also be tuned in a licensed frequency band.

Initially to tune the antenna 10, the antenna 10 is formed to have a configuration and size that corresponds to the frequency band within which the antenna 10 is to be used. In a preferred embodiment for the antenna 10, the antenna 10 has a bi-conical shape, with a pair of cone-shaped sections 18 extending outwardly in a radially expanding manner from a central section 20, which is preferably a data chip. The size of each of the cone-shaped sections 18 varies for each antenna 10 depending upon the particular frequency band to be received by the antenna 10. The following table provides the dimensions of each of the conical section 18 of the antenna 10 when configured for use in different frequency bands, such as microwave and millimeter wave frequency bands, among others.

TABLE 1
Sizes For 3D Antenna Sections For Use At Various Frequencies

| Antenna | Conical | Conical | Conical | |
|---|---|---|---|---|
| Frequency | Section | Section | Section | Central |
| Band | Upper Radius | Lower Radius | Height | Section |
| 2.45 GHz | 3.25 mm | 0.50 mm | 20.0 mm | 3.0 mm |
| 5.80 GHz | 1.37 mm | 0.50 mm | 7.9 mm | 3.0 mm |
| 63 GHz | 0.136 mm | 0.015 mm | 0.765 mm | 0.08 mm |

As can be seen from the above dimensions for the antennas 10 utilized at the various listed frequencies, using the three-dimensional approach in constructing the antennas 10 allows for the reduction in antenna length from conventional 2D antennas currently in use, and consequently also in area and size for the antenna 10. For example, a conventional 2D antenna configured for use within the microwave band at 2.45 GHz has a one-half wavelength dimension that is approximately sixty-one and one-half (61.5) millimeters in length. Using the three dimensional antenna configuration, the length of the 3D antenna 10 of the present invention used for the frequency band is reduced to forty-three (43) millimeters, i.e., the length of each conical section plus the length of the central section. In another example, a conventional 2D antenna modulating within the microwave band at 5.80 GHz has a one-half wavelength dimension that is twenty-six point four (26.4) millimeters in length. Using the three dimensional antenna configuration, the length of the antenna 10 constructed according to the present invention is reduced to eighteen point eight (18.8) millimeters. Further size reductions for the 3D antenna 10 are shown when the antenna 10 is constructed for use within the millimeter wave frequency band at 63 GHz.

With each of the configurations for the 3D antenna 10 for use at the various frequency bands discussed previously, in addition to making the required antenna size significantly smaller, and thereby reducing the size of the associate tag device 12, the size reduction in the antennas 10 at each band does not lessen the efficiency of the antennas 10. This is illustrated in the following table showing the radiation efficiencies of the respective antennas 10.

TABLE 2
Operation Parameters 3D Antennas At Various Frequency Bands

| | | | | Peak | Radiated | Accepted | Incident | |
|---|---|---|---|---|---|---|---|---|
| Antenna | Max U | Peak | Peak | Realized | Power | Power | Power | Radiation |
| Frequency | (W/sr) | Directivity | Gain | Gain | (W) | (W) | (W) | Efficiency |
| 2.45 GHz | 0.23225 | 2.9094 | 2.9199 | 2.9186 | 1.0032 | 0.99957 | 1.00 | 1.0036 |
| 5.80 GHz | 0.23089 | 2.8545 | 2.9063 | 2.9015 | 1.0165 | 0.99836 | 1.00 | 1.0181 |
| 63 GHz | 0.21361 | 2.6778 | 2.6844 | 2.6843 | 1.0024 | 0.99998 | 1.00 | 1.0025 |

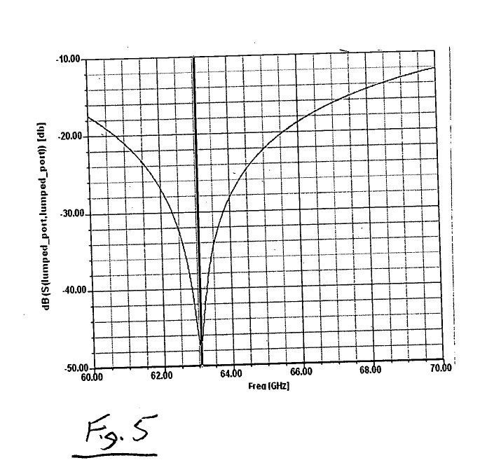

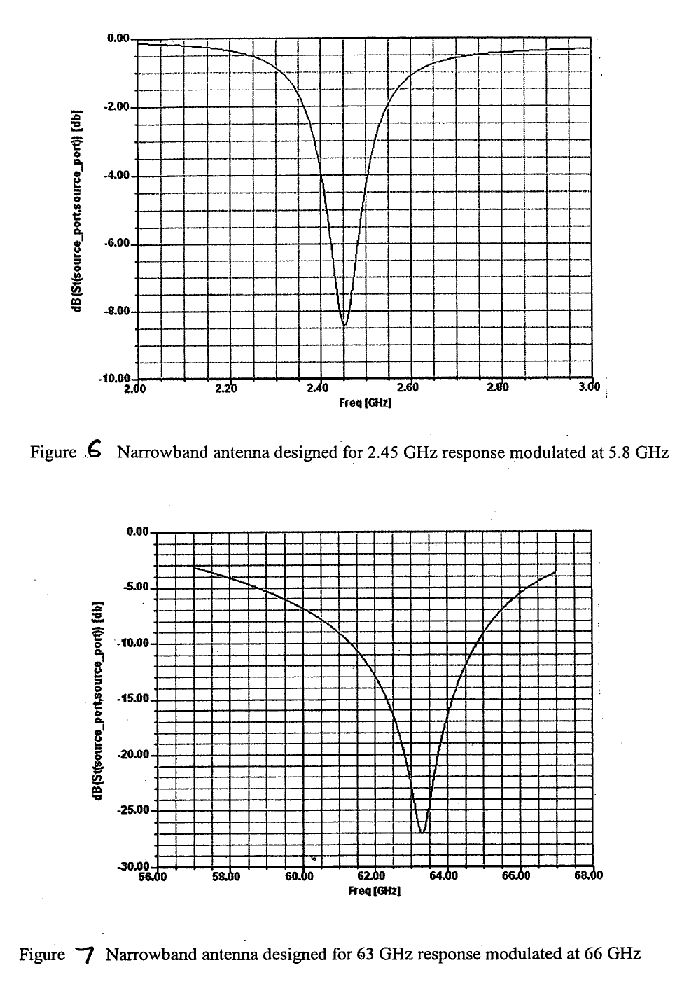

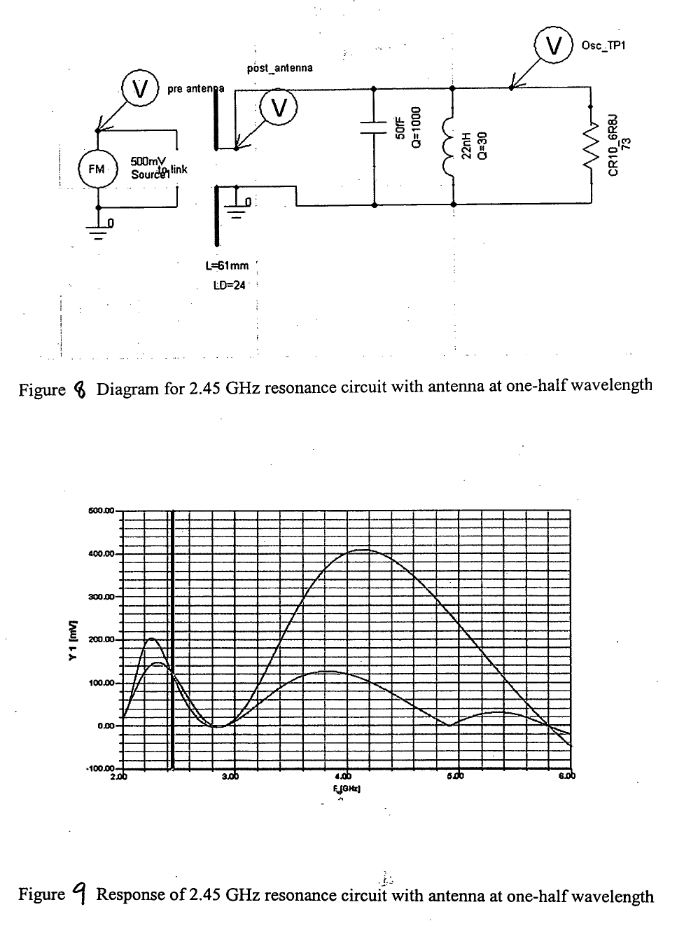

Additionally, the graphs presented in FIGS. 3-5 illustrate the return loss for each antenna 10 operating in the three frequency bands (2.45 GHz, 5.80 GHz and 63 GHz), which is minimal. In other words, as best shown in FIGS. 3-7, the return loss for the 3D antenna is less than a narrow band 2D antenna operating at a particular frequency, but the narrowband antenna cannot operate outside of the band to which it is tuned in contrast to the 3D antenna. Also, the return loss for the 3D antenna of the present invention is much less than for and broadband 2D antenna operating over the same frequency range.

In short, as illustrated by these results, the radiation efficiency of each 3D antenna 10 is maintained at one hundred percent, and the return loss is minimal, such that the reduction in size from the 3D antenna configuration does not negatively affect the ability of the antennas 10 to function in a manner similar to the conventional 2D antennas currently in use with RFID tag devices.

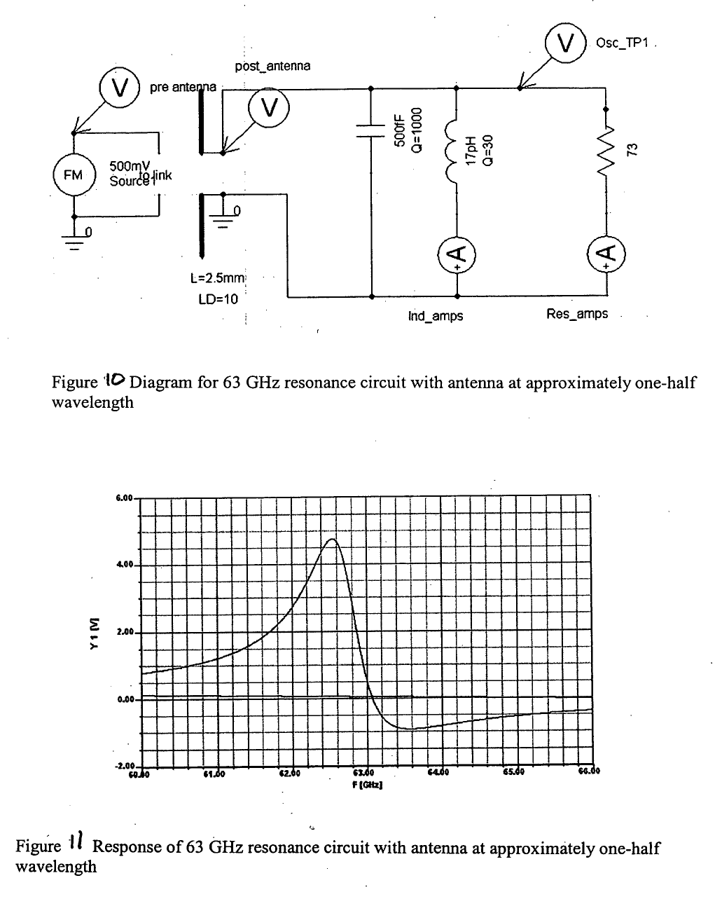

In employing the antennas 10 for use in RFID tag devices 12, in a preferred implementation, the RFID tag device 12 includes one or more resistors, one or more capacitors, one or more inductors (RLC's), one or more transistors to form a signal filter component 22 as shown in FIGS. 8 and 10 for antennas 10 tuned to 2.45 and 63 GHz with their responses illustrated in FIGS. 9 and 11, and a read-only or other data storage component 20, as is known. With this combination of components, the 3D antennas are each tuned to resonate at different frequencies within 2.45 GHz ISM band, 5.80 GHz Ultra-Wide band (UWB), 60 GHz millimeter wave frequencies and/or other unlicensed or licensed bands. The antennas 10 are tuned within these frequency bands to a particular frequency through the use of the signal filter such that the antenna 10 resonates only in response to signal received by the antenna 10 at that frequency within the particular frequency band. The tuning of the antennas 10 to a particular frequency within a given band essentially reduces the amount of bandwidth required for the proper operation of each individual antenna 10. This, in turn, divides the available bandwidth in the particular frequency band into a much larger number of potential narrowband frequencies or channels at which the antennas 10 and the RFID tag devices 12 to which they are attached can be tuned and operate in close proximity to one another without significantly interfering with one another. Additionally, because the individual frequencies for each antenna 10 and tag device 12 are distinct, the power required to send a signal either to or from the tag device 12 at that frequency over a distance similar to that for tag devices 12 using conventional antennas is reduced.

When a tag device 12 including these 3D antennas 10 and tuned to the specified frequency are used on various containers 16, the information or read data stored on the tag devices 12 can be accessed through the use of various RFID readers, as are known in the art. Due the large number of frequencies at which any individual tag device 12 with the 3D antenna 10 of the present invention can operate, the reader must be capable of moving through each of the tens or hundreds of channels or frequencies associated with the tens or hundreds of RFID tag devices 12 operating within the proper frequency band to access each of the tag devices 12. To do so, using one of the possible adaptive, sequential or random frequency hopping methods, the individual frequencies or channels within a given frequency band are scanned by the reader to determine whether any tag device 12 is operable at each of the frequencies in the band. If a tag device 12 is located at a particular frequency, the reader can identify and interpret each of the RFID tag devices 12 as an independent item, container or package based on the access code or protocol of the RFID tag device 12 that is transmitted to the reader in response to the interrogation signal sent from the reader on that frequency. In doing so, the standard hand-held device can be used for the transfer of data from the RFID tag device 12 as a mobile data routing device. In this manner, the reader can quickly scan a number of tag device 12 including the 3D antennas 10 to determine what items associated with the tag devices 12 are present without significant interference from one another, even though the tag device 12 are in close proximity to one another, such as when individual containers 16 including separate tag devices 12 are located on the same pallet (not shown).

However, reducing the bandwidth for the operation of each individual 3D antenna 10 and associated tag device 12 correspondingly reduces the amount of available wattage to power passive RFID tag devices 12. Nevertheless, to overcome this issue, the antennas 10 and the associated devices 12 can be configured to operate using a higher transmitting frequency that allows for the use of a higher power source per FCC licensing regulations for powering the passive RFID tag devices 12. In other terms, the RFID tag devices 12 can be powered by a higher unlicensed frequency band, e.g., 66 GHz for an antenna 10 configured for operation at 63 GHz. This allows for usage of available power for passive RFID tag activation from frequency bands that will not consume power from, or cause interference with or within the individual lower frequency bands or channels being used by the antennas 10 and tag devices 12. This further allows for the power supplied from the higher frequency bands to be more directed to the passive RFID tags 12, thereby limiting the amount of spurious and multi-path emissions associated with longer wavelength frequencies. However, the lower frequency and therefore longer physical antenna will still efficiently absorb this higher frequency source. Higher transmitting frequency source power allows for higher RFID tag device output signals and therefore longer read ranges per RFID tag device, if necessary. A higher transmit frequency source also allows for higher transmit antenna directivity and transmit antenna gains.

TABLE 3
Operational Parameters For 3D Antennas At Frequency Bands Above Configured Frequency Bands

| | | Maximum | | | Peak | Radiated | | Incident | |
|---|---|---|---|---|---|---|---|---|---|
| Antenna | Modulation | U | Peak | Peak | Realized | Power | Accepted | Power | Radiation |
| Frequency | Frequency | (W/sr) | Directivity | Gain | Gain | (W) | Power (W) | (W) | Efficiency |
| 2.45 GHz | 2.45 GHz | 0.23225 | 2.9094 | 2.9199 | 2.9186 | 1.0032 | 0.99957 | 1.00 | 1.0036 |
| 2.45 GHz | 5.80 GHz | 0.17827 | 5.3232 | 5.4822 | 2.2402 | 0.42084 | 0.40864 | 1.00 | 1.0299 |

TABLE 4
Operational Parameters For 3D Antennas At Frequency Bands Above Configured Frequency Bands

| | | Maximum | | | Peak | Radiated | | Incident | |
|---|---|---|---|---|---|---|---|---|---|
| Antenna | Modulation | U | Peak | Peak | Realized | Power | Accepted | Power | Radiation |
| Frequency | Frequency | (W/sr) | Directivity | Gain | Gain | (W) | Power (W) | (W) | Efficiency |
| 5.80 GHz | 5.80 GHz | 0.23089 | 2.8545 | 2.9063 | 2.9015 | 1.0165 | 0.99836 | 1.00 | 1.0181 |
| 5.80 GHz | 11.6 GHz | 0.18276 | 3.9141 | 4.0256 | 2.2967 | 0.58679 | 0.57053 | 1.00 | 1.0285 |

TABLE 5
Operational Parameters For 3D Antennas At Frequency Bands Above Configured Frequency Bands

| | | Maximum | | | Peak | Radiated | | Incident | |
|---|---|---|---|---|---|---|---|---|---|
| Antenna | Modulation | U | Peak | Peak | Realized | Power | Accepted | Power | Radiation |
| Frequency | Frequency | (W/sr) | Directivity | Gain | Gain | (W) | Power (W) | (W) | Efficiency |
| 63.0 GHz | 63.0 GHz | 0.21361 | 2.6778 | 2.6844 | 2.6843 | 1.0024 | 0.99998 | 1.00 | 1.0025 |
| 63.0 GHz | 66.0 GHz | 0.22969 | 2.8873 | 2.9285 | 2.8864 | 0.99968 | 0.98564 | 1.00 | 1.0142 |

In these situations, as shown in the results illustrated in Table 3-5, the antennas 10 enable the tag devices 12 with which they are associated to be powered with higher frequency and higher powered signals, while also maintaining the efficiency of the antennas 10, though the radiated/accepted power and the overall efficiency is reduced a small amount.

The embodiments presented herein are shown for illustrative purposes only. The invention is not limited to the embodiments shown herein. Various alternatives of the present invention discussed above are contemplated as being within the scope of the following claims particularly pointing out and distinctly claiming the subject matter regarded as the present invention.

I claim:

1. An antenna for use with a radio frequency identification device, the antenna comprising at least one three-dimensional conical section having a narrow end and a wide end.

2. The antenna of claim 1 wherein the at least one conical section is between about 0.75 mm and about 25.0 mm in height.

3. The antenna of claim 1 wherein the wide end of the at least one conical section is between about 0.1 mm and 4.0 mm in diameter.

4. The antenna of claim 1 wherein the narrow end of the at least one conical section is between about 0.01 mm and about 1.0 mm in diameter.

5. The antenna of claim 1 further comprising:
a) a pair of opposed three-dimensional conical sections each having a narrow end and a wide end; and
b) a central section connected to the narrow end of each conical section.

6. The antenna of claim 5 wherein the central section is between 0.05 mm and 5.0 mm in height.

7. A radio frequency identification device comprising:
a) a tuning filter component including at least one resistor, at least one capacitor and at least one inductor;
b) a data storage component; and
c) a three-dimensional antenna operably connected to the tuning filter component and the data storage component.

8. The device of claim 7 wherein the device is a passive device.

9. The device of claim 8 wherein the three-dimensional antenna is configured to transfer data utilizing signals within a first frequency band and to draw power from signals within a second frequency band.

10. The device of claim 9 wherein the second frequency band is higher than the first frequency band.

11. The device of claim 7 wherein the tuning filter component and the antenna are tuned to resonate at a specific frequency within a first frequency band.

12. The device of claim 11 wherein the resonance frequency or the tuning filter component and the antenna is randomly selected.

13. The device of claim 7 further comprising a housing that encloses the tuning filter component, the data storage component and the antenna.

14. The device of claim 13 wherein the housing is securable to another item.

15. The device of claim 14 wherein the housing is adhesively securable to another item.

16. A system for identifying items utilizing wireless signals, the system comprising:
a) a plurality of radio frequency identification devices adapted to be secured to the items, each device including a tuning filter component, a data storage component for storing identifying information on the item, and a three-dimensional antenna, the device being tuned to a specific frequency within a first frequency band; and
b) a wireless signal generating and receiving device capable of operating in an adaptive, sequential or random frequency-hopping manner across the entire first frequency band to communicate with the plurality of devices using the resonant frequency for each of the plurality of devices.

17. The system of claim 16 wherein each of the plurality of devices are passive devices, and wherein the plurality of devices are each tuned to receive power from a signal from a second frequency band.

18. A method for forming a radio frequency identification device, the method comprising the steps of:
a) providing a three-dimensional antenna configured for use within a first frequency band;
b) connecting the antenna to a tuning filter component and a data storage component; and
c) tuning the antenna with the filter component to have a single resonant frequency within the first frequency band.

19. The method of claim 18 wherein the step of tuning the antenna further comprises configuring the antenna to enable the antenna to receive power from a signal from a second, higher frequency band.

20. The method of claim 19 wherein the first frequency band is selected from the group consisting of 2.45 GHz, 5.80 GHz and 63 GHz, and the second frequency band is selected from the group consisting of 5.80 GHz, 11.6 GHz and 60-66 GHz.
